(19) United States
(12) Patent Application Publication
(10) Pub. No.: US 2015/0181414 A1
(43) Pub. Date: Jun. 25, 2015

(54) DISCOURAGING TEXT MESSAGING WHILE DRIVING

(71) Applicant: MOTOROLA MOBILITY LLC, Chicago, IL (US)

(72) Inventors: John T. Bretscher, Elgin, IL (US); William S. Hede, Lake in the Hills, IL (US)

(21) Appl. No.: 14/296,865

(22) Filed: Jun. 5, 2014

Related U.S. Application Data
(60) Provisional application No. 61/918,752, filed on Dec. 20, 2013.

(51) Int. Cl. H04W 8/22; H04W 4/12

(52) U.S. Cl. CPC H04W 8/22; H04W 4/12

(57) ABSTRACT

A texting-while-driving-discouragement system (108) operates to discourage users from text messaging while driving. The system determines (306) whether a user is driving a vehicle, determines (308) whether the vehicle is moving at a speed that satisfies a threshold speed, and determines (310) whether the user is text messaging. In response to determining that the user is driving the vehicle, the vehicle is moving at a speed that satisfies the threshold speed, and the user is text messaging, a remedial action is taken (312). Various remedial actions can be taken such as imposing a fee on the user (e.g., a fee that the user has optionally previously agreed to pay if he is text messaging while driving), disabling text messaging for the device, providing the user with the option to hear received text messages audibly or input verbally text messages to be sent, and so forth.

### RELATED APPLICATIONS

This application claims the benefit of U.S. Provisional Application Ser. No. 61/918,752 filed Dec. 20, 2013, the entire contents of which are hereby incorporated herein by reference in their entirety.

### BACKGROUND

Text messaging requires a level of concentration for people that is not compatible with simultaneously driving a motor vehicle. A person paying attention to the screen of a wireless-communications device is simply not paying as much attention as he should to his driving. Because of this, many jurisdictions have passed laws restricting text messaging while driving or banning it outright. However, some people continue to violate these laws. Texting while driving thus remains a problem, endangering the people texting as well as others.

### BRIEF DESCRIPTION OF THE DRAWINGS

Embodiments of discouraging text messaging while driving are described with reference to the following drawings. The same numbers are used throughout the drawings to reference like features and components:

FIG. 1 illustrates an example environment in which text messaging while driving can be discouraged in accordance with one or more embodiments;

FIG. 2 illustrates an example texting-while-driving-discouragement system in accordance with one or more embodiments;

FIG. 3 illustrates an example process for discouraging text messaging while driving in accordance with one or more embodiments;

FIG. 4 illustrates an example wireless device in accordance with one or more embodiments;

FIG. 5 illustrates another example process for discouraging text messaging while driving in accordance with one or more embodiments; and

FIG. 6 illustrates various components of an example electronic device that can implement embodiments of the techniques discussed herein.

### DETAILED DESCRIPTION

Discouraging text messaging while driving is discussed herein. Using the techniques discussed herein, a determination is made as to whether a user is driving a vehicle (e.g., rather than being a passenger in the vehicle), whether the vehicle is moving at a speed that satisfies a threshold speed (e.g., faster than the threshold speed), and whether the user is text messaging. In response to determining that the user is driving the vehicle, the vehicle is moving at a speed that satisfies the threshold speed, and the user is text messaging (also referred to as texting), a remedial action is taken. One or more of a variety of different remedial actions can be taken such as imposing a significant fee on the user (e.g., a fee that the user has optionally previously agreed to pay if he is text messaging while driving), refusing to send text messages, notifying another user or entity, providing the user with the option to hear received text messages audibly or send text messages verbally, and so forth.

Using the techniques discussed herein, barriers are put in place or actions are taken to discourage text messaging while driving. The techniques discussed herein do not require promulgation of additional legislation banning or restricting text messaging while driving. Rather, the remedial actions of the techniques discussed herein provide the discouragement for people to text message while driving.

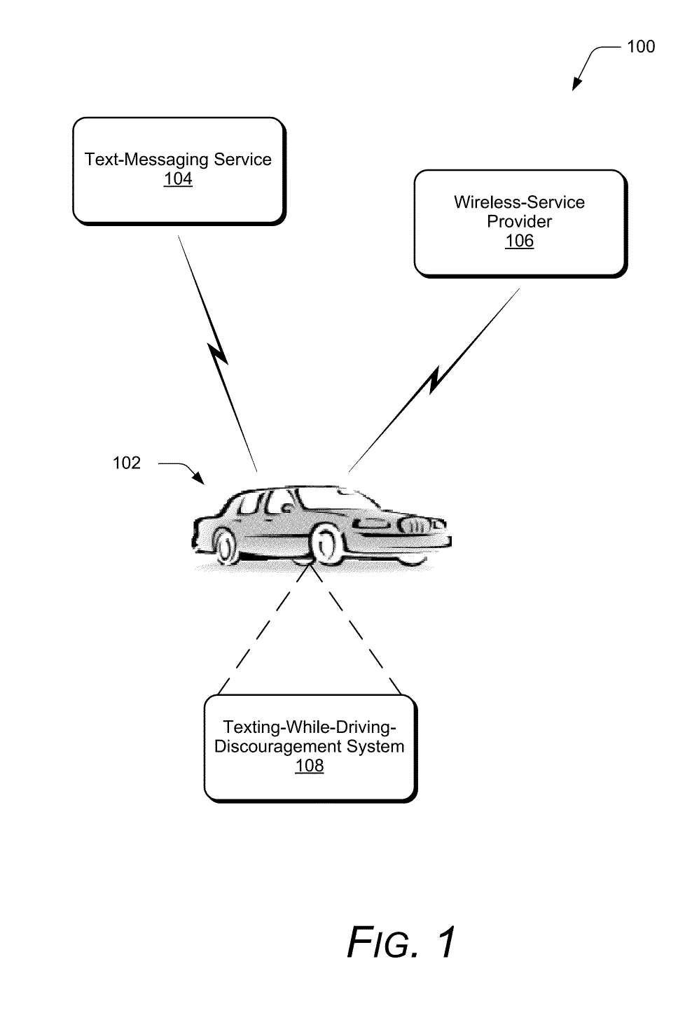

FIG. 1 illustrates an example environment 100 in which text messaging while driving can be discouraged in accordance with one or more embodiments. The environment 100 includes a vehicle 102, a text-messaging service 104, and a wireless-service provider 106. The vehicle 102 represents any of a variety of different vehicles that may be driven by a user such as a car, truck, motorcycle, boat, plane or other aircraft, train or other vehicle driven on a track or rails, and so forth. The text-messaging service 104 and the wireless-service provider 106 can each include one or more of a variety of different computing devices (e.g., server computers). Although illustrated as separate services, it should be noted that the text-messaging service 104 can optionally be included as part of the wireless-service provider 106.

The user has a wireless-communications device that he can use for various communications including text messaging. Text messaging refers to the user using his wireless-communications device to send or receive text messages. The user's wireless-communications device (also referred to herein as simply the user's device) is a mobile device such as a cellular or other wireless phone, a tablet, an audio/video playback device, and so forth. The user's wireless-communications device can also take other forms such as an automotive PC of the vehicle 102. The text-messaging service 104 supports text messaging for the user of the vehicle 102. The text-messaging service 104 receives text messages from the user's device in the vehicle 102 and routes such received text messages to their intended recipients. The text-messaging service 104 also receives text messages targeting the user (or the user's device) of the vehicle 102 and routes such received text messages to the user's device in the vehicle 102.

The text-messaging service 104 can support text messaging using any of a variety of public or proprietary messaging techniques or protocols such as short message service, multimedia messaging service, and so forth. Although reference is made herein to text messaging and text messages, it should be noted that such messages can optionally include data of other media forms in addition to or in place of text such as audio data, image data, video data, and so forth. The text-messaging service 104 can support text messages sent using any of a variety of public or proprietary communication networks.

The wireless-service provider 106 manages wireless accounts for users. A user's wireless account is associated with one or more of the user's devices. For example, the wireless-service provider 106 can be a cellular or other wireless-phone-service provider. In one or more embodiments, the user has an agreement with the wireless-service provider 106 that specifies one or more remedial actions that the user authorizes to be taken in response to the user text messaging while driving. These remedial actions can include fees, notifications to other users or entities, and so forth as discussed in more detail below.

The user's device includes a texting-while-driving-discouragement system 108. The texting-while-driving-discouragement system 108 determines whether the user is text messaging while driving and takes a remedial action in response to determining that the user is text messaging while driving. Although illustrated as part of the user's device in the vehicle 102 of FIG. 1, the texting-while-driving-discouragement system 108 can alternatively be implemented on multiple devices, one or more of which may be remote from the vehicle 102. For example, the system 108 can be implemented at least in part by the text-messaging service 104 or the wireless-service provider 106.

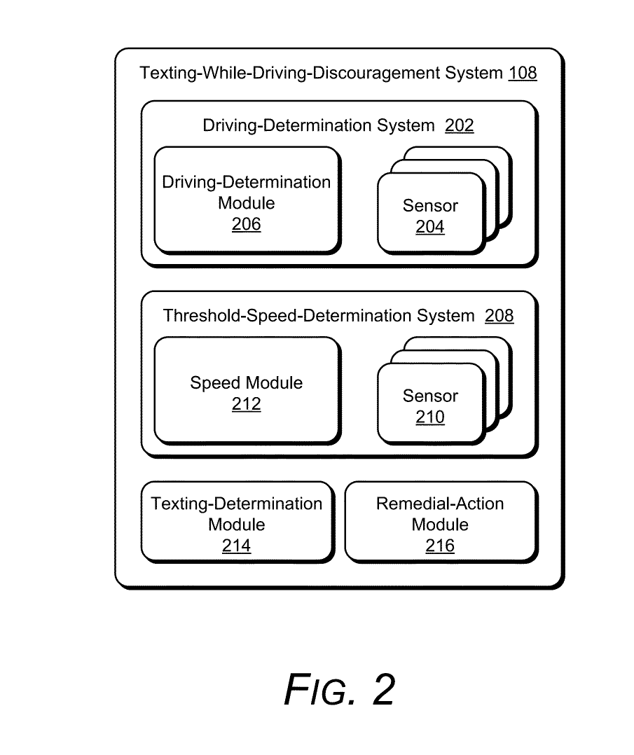

FIG. 2 illustrates an example texting-while-driving-discouragement system 108 in accordance with one or more embodiments. The system 108 can be implemented on a single computing device, such as a user's wireless-communications device. Alternatively, the system 108 can be implemented on multiple devices such as a user's wireless-communications device, one or more server devices of a remote service, combinations thereof, and so forth.

The texting-while-driving-discouragement system 108 includes a driving-determination system 202 having one or more sensors 204 and a driving-determination module 206, a threshold-speed-determination system 208 having one or more sensors 210 and a speed module 212, a texting-determination module 214, and a remedial-action module 216. Different ones of system 202, system 208, module 214, and module 216 can be implemented on the same device, or alternatively different ones of system 202, system 208, module 214, and module 216 can be implemented on different devices. Additionally, for each of system 202, system 208, module 214, and module 216, the functionality of the system or module can be implemented on one device or across multiple devices. For example, the functionality of a system 202 or 208, or a module 214 or 216, may be performed in part by the user's wireless-communications device and in part by a remote server accessed by the user's wireless-communications device.

Although particular functionality is discussed herein with reference to particular systems and modules, it should be noted that the functionality of individual systems and modules can be separated into multiple systems or modules. It should also be noted that at least some functionality of multiple systems or modules can be combined into a single system or module. Additionally, a particular system or module discussed herein as performing an action includes that particular system or module itself performing the action or alternatively that particular system or module invoking or otherwise accessing another component, system, or module that performs the action (or performs the action in conjunction with that particular system or module). Thus discussion of a particular system 202, system 208, module 214, and module 216 performing an action includes that particular system 202, system 208, module 214, and module 216 itself performing the action or another system or module invoked or otherwise accessed by that system 202, system 208, module 214, and module 216 performing the action.

Generally, the driving-determination system 202 determines whether a user is driving a vehicle, the threshold-speed-determination 208 determines whether the vehicle is traveling at a speed that satisfies a threshold speed, and the texting-determination module 214 determines whether the user is texting. The remedial-action module 216, in response to determinations being made that the user is driving the vehicle at a speed that satisfies the threshold speed and is texting, takes one or more remedial actions.

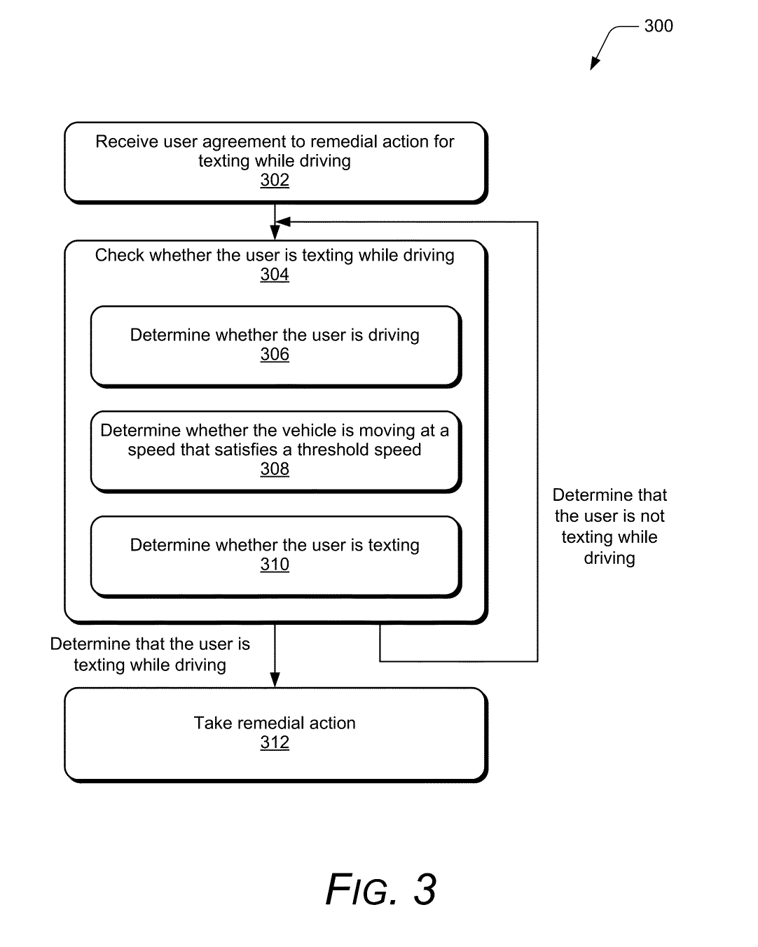

FIG. 3 illustrates an example process 300 for discouraging text messaging while driving in accordance with one or more embodiments. Process 300 is carried out at least in part by a system such as texting-while-driving-discouragement system 108 of FIGS. 1 and 2 and can be implemented in software, firmware, hardware, or combinations thereof. Process 300 is shown as a set of acts and is not limited to the order shown for performing the operations of the various acts. Process 300 is discussed with additional reference to FIGS. 1 and 2.

In process 300 user agreement to a remedial action for texting while driving is received (act 302). In one or more embodiments, the user enters into a contractual agreement with a service provider that provides wireless service to his device. In the agreement the user agrees to refrain from text messaging while driving and agrees to accept one or more remedial actions if he were to engage in text messaging while driving. The specific remedial actions such as a significant fee (e.g., a fee greater than a threshold amount such as twice or triple the user's typical monthly service fee) to be charged to the user can optionally be specified in the agreement. The agreement is received by the wireless-service provider such as by the wireless-service provider 106. The agreement, or indication of the agreement, can optionally be received by the texting-while-driving-discouragement system 108 as well. Receipt of the agreement, or an indication of the agreement, can optionally be used to enable the system 108 to monitor the user's behavior or device for texting while driving.

A check is made as to whether the user is texting while driving (act 304). Whether the user is texting while driving is determined by determining whether the user is driving (act 306), whether the vehicle is moving at a speed that satisfies a threshold speed (act 308), and whether the user is texting (act 310). The determinations in acts 306, 308, and 310 can be performed in any order or concurrently. Additionally, one or more determinations in acts 306, 308, and 310 can be made in response to another determination being made (e.g., one determination need not be made until triggered by another determination). For example, the vehicle speed may be monitored, and no determination made as to whether the user is driving (act 306) or texting (act 310) until it is determined that the vehicle is moving at a speed that satisfies a threshold speed (act 308). By way of another example, whether the user is texting may be monitored, and no determination made as to whether the user is driving (act 306) or the vehicle is moving at a speed that satisfies a threshold speed (act 308) until it is determined that the user is texting (act 310).

The driving-determination system 202 determines whether the user is driving (act 306). The driving-determination module 206 can determine whether the user is driving in a variety of different manners, and the determination can be based at least in part on the one or more sensors 204. In one or more embodiments, the one or more sensors include one or more seat sensors in the vehicle 102. Seat sensors in the vehicle 102 can determine which seats are occupied at any given time (e.g., based on pressure applied to the sensors due to weight in the seats). The seat sensor information can be used in various manners to determine whether the user is driving the car. For example, if the one or more seat sensors indicate that the only person in the car is in the driver's seat, then the user in the car can be determined to be driving the car. By way of another example, if the one or more seat sensors indicate that people are sitting in the driver's seat as well as front passenger seat of the car, then additional information can be used to determine whether the user is driving the car.

Another way in which the driving-determination module 206 can determine whether the user is driving is based on beam steering. The user's device can emit a signal, and the one or more sensors 204 include one or more antennas or other receivers in the vehicle 102 that determine, based on the received signal, which seat of the vehicle the user's device is most likely to be in (which seat has a person sitting in it that is most likely to be holding the user's device). This determination can be made, for example, using a variety of public or proprietary signal processing techniques. The signal emitted by the user's device can be specific to determining whether the user is driving or can be used to provide additional functionality (e.g., the signal can be a wireless Bluetooth signal).

Another way in which the driving-determination module 206 can determine whether the user is driving is based on one or more cameras in the vehicle 102. The one or more sensors 204 include one or more cameras, and images captured by the one or more cameras can be analyzed to determine which seats in the vehicle 102 are occupied at any given time. Face recognition techniques can optionally be used to identify which particular seat the user is in at any given time if multiple seats are occupied. For example, the user of a device can have previously had an image of his face captured and stored, and the module 206 can use the stored image of the user's face to identify which person in the vehicle is the user and whether the user is sitting in the driver's seat.

Another way in which the driving-determination module 206 can determine whether the user is driving is based on a short-range signal (e.g., radio transmission), and the one or more sensors 204 include one or more receivers in the user's device. A transmitter in the vehicle 102 emits a signal having a short enough range that the signal can be detected by one or more receivers of the user's device if the device is held by a user in a driver's seat of the vehicle 102 but not if the device is held by a user in another seat of the vehicle 102. The transmitter can be situated in the vehicle 102 to facilitate such signaling and reception such as being situated in the steering wheel of the vehicle 102, being situated in the front of the driver's-side door of the vehicle 102, and so forth. The signal can be transmitted using various technologies, such as near-field communication technologies.

Another way in which the driving-determination module 206 can determine whether the user is driving is based on an ultra-high frequency signal emitted by a speaker in the vehicle 102, and the one or more sensors 204 include one or more receivers in the user's device. The ultra-high frequency signal is a signal that is not audible to people in the car (or typically is not audible to most people in the car) but can be sensed by one or more receivers in the user's device. The ultra-high frequency signal can be emitted from a speaker that is expected to be closest to the driver's seat of the vehicle 102 such as a speaker situated in the front of the driver's side door of the vehicle 102. If the sensor in the user's device senses the ultra-high frequency signal having at least a threshold strength (e.g., at least a threshold volume), then the user's device is determined as being close to (e.g., held) by the user in the driver's seat of the vehicle 102, and the user is thus determined to be driving the vehicle 102.

Another way in which the driving-determination module 206 can determine whether the user is driving is based on whether the user has logged into or otherwise identified himself as the driver of the vehicle 102. For example, the user may log into or otherwise identify himself (e.g., using a password, using voice recognition, using face recognition, etc.) to a computing device of the vehicle 102. The user's wireless-communications device can be the device that the user has logged into or otherwise identified himself to. Alternatively, the device that the user has logged into or otherwise identified himself to can be another device linked to or otherwise associated with a same account of the user.

The driving-determination module 206 can optionally use multiple techniques to determine whether the user is driving. For example, if one or more seat sensors 204 in the vehicle 102 indicate that people are sitting in the driver's seat as well as the front passenger seat of the car, then an ultra-high frequency signal can be used to determine whether the user's device is close to the user in the driver's seat. If the one or more sensors 204 of the user's device sense the ultra-high frequency signal having at least a threshold strength, then the user is determined to be driving the vehicle 102, and if the one or more sensors 204 of the user's device do not sense the ultra-high frequency signal having at least a threshold strength, then the user is determined to not be driving the vehicle 102. By way of another example, if one or more cameras in the vehicle 102 indicate that people are sitting in the driver's seat as well as a second row of seats, then a transmitter in the vehicle 102 can emit a short-range signal. If the one or more sensors 204 of the user's device detect the short-range signal, then the user is determined to be driving the vehicle 102, and if one or more sensors 204 of the user's device do not detect the short-range signal, then the user is determined to not be driving the vehicle 102.

The speed module 212 determines whether the vehicle is moving at a speed that satisfies a threshold speed (act 308). The speed of the vehicle 102 can be determined in various manners using one or more sensors 210 that can be a speedometer of the vehicle 102, Global Positioning System sensors of the user's device or the vehicle 102, and so forth. The speed of the vehicle satisfies the threshold speed if the speed of the vehicle is faster than the threshold speed or alternatively if the speed of the vehicle is faster than or equal to the threshold speed. In one or more embodiments, the threshold speed is zero miles per hour. Alternatively other values can be used such as a speed that is expected to be the fastest speed that a user would be walking while texting with his device (e.g., 5 miles per hour).

The texting-determination module 214 determines whether the user is texting (act 310). The texting-determination module 214 can determine whether the user is texting in a variety of different manners. In one or more embodiments, the texting-determination module 214 determines whether a texting application is running on the user's device or is a currently active application on the user's device. The module 214 can determine that the user is texting if the texting application is running on the user's device or is a currently active application on the user's device. The module 214 can determine that the user is not texting if the texting application is not running on the user's device or is not a currently active application on the user's device.

Another way in which the texting-determination module 214 can determine whether the user is texting is by determining whether the user is interacting with a keyboard of his device. The keyboard can include physical keys or alternatively can be a soft keyboard with keys displayed on a touchscreen. Whether the user is interacting with a keyboard of his device can be determined in different manners such as whether the user is providing inputs to the keyboard (e.g., whether a key has been selected by the user in a preceding threshold number of seconds or at a threshold rate), whether the keyboard is activated (e.g., whether the keyboard is displayed on the touchscreen), whether a particular number of keys have been pressed (e.g., a threshold number of keys have been selected by the user or a word has been entered by the user), whether one or more particular keys are selected by the user (e.g., a “send” or “enter” key has been selected or a threshold number of character keys followed by a space have been entered), and so forth. The module 214 can determine that the user is texting if the user is interacting with a keyboard of his device and can determine that the user is not texting if the user is not interacting with a keyboard of his device.

If the user is determined to be driving (act 306), the vehicle is determined to be moving at a speed that satisfies a threshold speed (act 308), and the user is determined to be texting (act 310), then a remedial action is taken (act 312). However, if the user is determined to not be driving (act 306), or the vehicle is determined to not be moving at a speed that satisfies a threshold speed (act 308), or the user is not determined to be texting (act 310), then the process 300 continues to check whether the user is texting while driving (act 304).

The remedial-action module 216 takes a remedial action in response to a determination that the user is texting while driving. The remedial-action module 216 can take a variety of different remedial actions. In one or more embodiments, the remedial action that the module 216 takes is to have the user charged a significant (e.g., greater than a threshold amount) fee. This fee is an increased fee for service due to the user text messaging while driving. The module 216 can have the amount charged, for example, by sending a notification to the wireless-service provider 106 that the user is text messaging while driving. The notification can be, for example, an email message, a text message, another report or indication, and so forth. The notification sent to the wireless-service provider 106 can include various additional information such as information relating to an identity of the user, information relating to an identity of the user's device, an indication of the speed of the vehicle 102 (e.g., absolutely or with respect to the threshold), information regarding the user's text messaging, and so forth.

It should be noted that with this remedial action the user is not prevented from text messaging but is charged a significant amount of money to do so. The amount of money charged can vary but is designed to be large enough so that it acts as a deterrent to the user text messaging while driving. The user can optionally be provided with a warning (e.g., on a display of his device or an audible warning), that by text messaging while driving, the user is going to incur a significant fee. The user is thus given the opportunity to cease his actions and avoid the significant fee. The fee is charged to the user only if the user continues with text messaging while driving after being provided with the warning. The fee is collected by the wireless-service provider and can be kept by the wireless-service provider or alternatively donated to any of a variety of charitable organizations.

Another remedial action that the remedial-action module 216 can take is to prevent or disable text messaging in various manners. The remedial-action module 216 can interact with one or more other components of the user's device (or the text-messaging service 104) to prevent text messages from being sent or received by the user's device. Alternatively, the remedial-action module 216 can interact with one or more other components of the user's device to prevent text messages from being displayed by the user's device, to prevent a text-messaging application from running or accepting user inputs, to deactivate a keyboard, and so forth. Text messaging can be re-enabled in response to the user no longer driving the vehicle or the vehicle no longer traveling at a speed that satisfies the threshold speed.

Another remedial action that the remedial-action module 216 can take is to have received text messages played back audibly to the user and allow the user to input text messages (and optionally identify recipients of text messages) verbally. The remedial-action module 216 can play back the text messages audibly and receive input text messages from the user verbally, or alternatively, can communicate with one or more other components of the user's device or another device (e.g., stereo of the vehicle 102) to do so. Thus the user is allowed to continue with text messaging but does so in a hands-free manner, which allows the user to keep his eyes on the road.

The audible playback and verbal input of text messages can be invoked in various manners. For example, the remedial-action module 216 can automatically have text messages played back audibly and input verbally (e.g., based on a configuration or preference setting of the user's device that can optionally be changed by the user to select whether such automatic text message playback and verbal input is to be used). By way of another example, the module 216 can present a user interface (UI) to the user (e.g., display a dialog box, play back an audible message) notifying the user that he has been determined to be or about to be text messaging while driving and allowing the user to select an option (e.g., touch a button of a keyboard, provide a verbal input) to have text messages played back audibly and input verbally. Alternatively, the module 216 may allow the user to select an option to send a pre-determined or pre-canned text message in reply to a received text message. The pre-determined or pre-canned text message can, for example, notify the sender of the received text message that the user is driving but will respond as soon as it is safe to do so.

In one or more embodiments, a UI allowing the user to select an option to have text messages played back audibly and input verbally can be presented to the user in response to receipt of a text message even if the user has not otherwise been determined to be texting. For example, the user may not have interacted with a keyboard of his device, but the text-messaging application may have become a currently active application in response to receipt of the message. Thus, in response to receipt of a text message, the UI can be presented to the user allowing the user to have text messages played back audibly and input verbally.

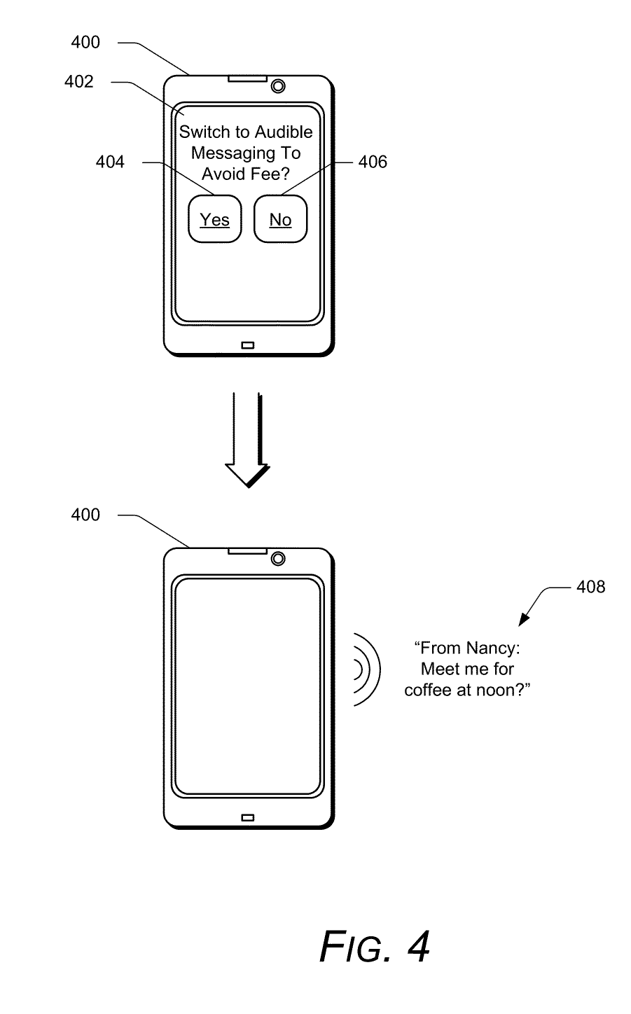

FIG. 4 illustrates an example wireless device 400 in accordance with one or more embodiments. The device 400 displays a UI on a touchscreen 402 asking the user if he desires to switch to audible messaging in order to avoid a fee. The UI can be displayed in response to various events such as receipt by the device 400 of a text message from another user, the user of the device 400 requesting to run a text-messaging application while the user is driving the vehicle 102 at a speed that satisfies a threshold speed, and so forth. The UI includes buttons 404 and 406 that can be selected by the user to indicate whether he desires to switch to audible messaging (in response to selection of the button 404) or not switch to audible messaging (in response to selection of the button 406). Alternatively, the device 400 can play back an audible message asking the user if he desires to switch to audible messaging in order to avoid a fee, or the user can input a “yes” or “no” selection verbally rather than selecting a button 404 or 406.

Audible messaging refers to text messaging in situations where received text messages are played back audibly by the device 400, and text messages to be sent by the device 400 are input verbally by the user of the device 400. Thus, rather than having the user look at and interact with the touchscreen 402, the user is able to interact with the device 400 in a verbal and hands-free manner allowing the user to, for example, keep his eyes on the road.

In response to a user input indicating that the user desires to switch to audible messaging (e.g., in response to selection of the button 404), the device 400 ceases displaying the user interface on the touch screen 404. The device 400 plays back a received text message illustrated in FIG. 4 as the audible playback of a text message from another user named Nancy, with the message “Meet me for coffee at noon?”. The device 400 can continue to play back received text messages audibly, and the user can input text messages verbally until any of a variety of different events occurs such as the user requests that such audible messaging no longer be used or the user is no longer determined to be text messaging while driving (e.g., the user is determined to not be driving, or the vehicle is determined to not be moving at a speed that satisfies a threshold speed, or the user is not determined to be texting).

If the user input indicates that the user does not desire to switch to audible messaging, the device 400 can optionally display received text messages on the touchscreen 402. A keyboard allowing the user to input text messages can also optionally be displayed on the touchscreen 402. Additional remedial actions can also be taken, such as charging the user a fee for text messaging while driving.

Returning to FIG. 3, another remedial action that the remedial-action module 216 can take is to notify one or more other entities (e.g., individuals, companies, etc.) that the user is text messaging while driving. The notification can be, for example, an email message, a text message, another report or indication, and so forth. The other entities can include, for example, other users such as an owner or responsible party for the wireless-service provider account that the user's device is part of (e.g., the user's parent or employer), law enforcement personnel, court systems (e.g., probation officers), vehicle-insurance companies, vehicle-rental companies, local municipalities, and so forth.

The driving remedial-action module 216 can optionally take multiple remedial actions. For example, the module 216 can notify the wireless-service provider 106 that the user is text messaging while driving and also send emails to one or more other entities that the user is text messaging while driving. By way of another example, the module 216 can deactivate the keyboard of the user's device and have text messages played back audibly and input text messages received from the user verbally.

It should be noted that, in the discussions above, the remedial action in act 312 is discussed as being taken if the user is determined to be driving (act 306), the vehicle is determined to be moving at a speed that satisfies a threshold speed (act 308), and the user is determined to be texting (act 310). These determinations can be all made by the same device (e.g., the user's device) or by different devices. For example, the user's device may determine that the user is driving (act 306) and the user is texting (act 310) and send a notification of these determinations to the wireless-service provider (e.g., wireless-service provider 106). The notification can include a notification of the speed of the vehicle 102, and the wireless-service provider can determine whether the vehicle is moving at a speed that satisfies a threshold speed and thus whether remedial action is to be taken in act 312.

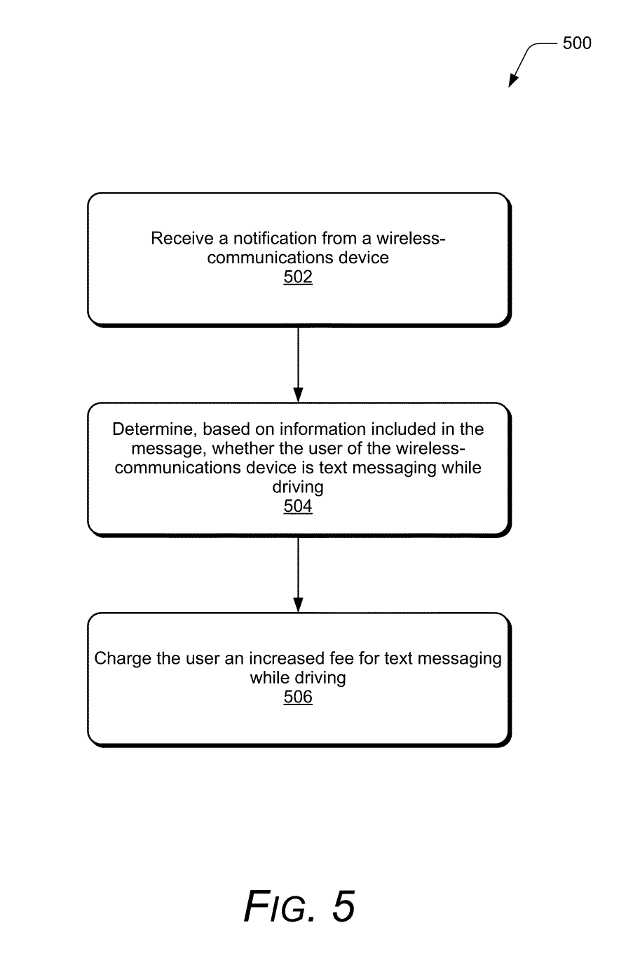

FIG. 5 illustrates an example process 500 for discouraging text messaging while driving in accordance with one or more embodiments. Process 500 is carried out at least in part by a wireless-service provider such as wireless-service provider 106 of FIG. 1 and can be implemented in software, firmware, hardware, or combinations thereof. Process 500 is shown as a set of acts and is not limited to the order shown for performing the operations of the various acts. Process 500 is discussed with additional reference to FIGS. 1 and 2.

In process 500, a notification is received from a wireless-communications device (act 502). The notification can be received from a wireless-communications device in a vehicle 102. Alternatively, the notification can be received from another module, component, or system of a vehicle 102.

A determination is made, based on information included in the notification, whether the user of the wireless-communications device is text messaging while driving (act 504). The notification can include an indication that the user has been determined to have been text messaging while driving by the user's device. Alternatively, the notification can include information allowing the wireless-service provider to make the determination as to whether the user is text messaging while driving (e.g., the notification can include a notification of the speed of the vehicle 102, and the wireless-service provider can determine whether the vehicle is moving at a speed that satisfies a threshold speed).

In response to determining that the user of the wireless-communications device is text messaging while driving, an increased fee is charged to the user (act 506). The increased fee is a fee for text messaging while driving, as discussed above, and can be a fee previously agreed to by the user of the wireless-communications device. Whether the increased fee is charged to the user is at the discretion of the wireless-service provider; the wireless-service provider can optionally implement additional rules or criteria as desired by the wireless-service provider in determining whether the increased fee is charged to the user. Various other remedial actions can also be taken in addition to, or in place of, the fee being charged in act 506.

It should be noted that additional actions can also optionally be taken which may or may not be classified as remedial actions. For example, notifications (e.g., email messages, text messages, other reports or indications, etc.) can be provided to one or more entities to notify such entities that the user is not text messaging while driving. For example, other entities can be notified that the user always (or almost always) has text messages played back audibly and input text messages provided by the user verbally rather than continuing with text messaging via a keyboard and display and thus incurring significant charges. These notifications can thus be positive reinforcements to discourage users from text messaging while driving.

It should also be noted that various additional warnings regarding the dangers of text messaging while driving can be presented to the user of the device at various times. These warnings may be based on one or more of the user being determined to be driving a vehicle, the vehicle moving at a speed that satisfies a threshold speed, or the user text messaging. For example, a warning regarding the dangers of text messaging while driving can be displayed or otherwise presented to the user in response to both a determination that the user is driving a vehicle and the user receives a text message from another user.

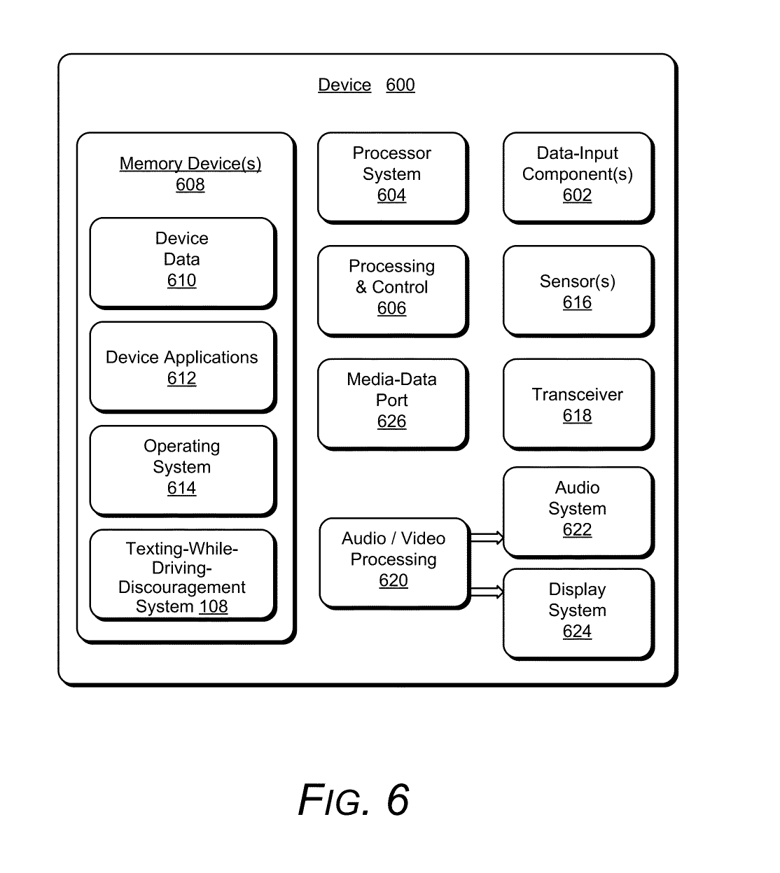

FIG. 6 illustrates various components of an example electronic device 600 that can be implemented as a device as described with reference to any of the previous FIGS. 1-5. The device may be implemented as any one or combination of a fixed or mobile device in any form of a consumer, computer, portable, user, communication, phone, navigation, gaming, messaging, Web browsing, paging, media playback, or other type of electronic device such as a wireless-communications device in a vehicle 102 described with reference to FIG. 1, or a server device of a text-messaging service 104 described with reference to FIG. 1, or a server device of a wireless-service provider 106 described with reference to FIG. 1.

The electronic device 600 can include one or more data-input components 602 via which any type of data, media content, or inputs can be received such as user-selectable inputs, messages, music, television content, recorded video content, and any other type of audio, video, or image data received from any content or data source. The data-input components 602 may include various data-input ports such as universal serial bus ports, coaxial cable ports, and other serial or parallel connectors (including internal connectors) for flash memory, DVDs, compact discs, and the like. These data-input ports may be used to couple the electronic device to components, peripherals, or accessories such as keyboards, microphones, or cameras. The data-input components 602 may also include various other input components such as microphones, touch sensors, keyboards, and so forth.

The electronic device 600 of this example includes a processor system 604 (e.g., any of microprocessors, controllers, and the like) or a processor and memory system (e.g., implemented in a system on a chip), which processes computer-executable instructions to control operation of the device. A processing system may be implemented at least partially in hardware that can include components of an integrated circuit or on-chip system, an application-specific integrated circuit, a field-programmable gate array, a complex programmable logic device, and other implementations in silicon or other hardware. Alternatively or in addition, the electronic device can be implemented with any one or combination of software, hardware, firmware, or fixed-logic circuitry implemented in connection with processing and control circuits that are generally identified at 606. Although not shown, the electronic device can include a system bus or data transfer system that couples the various components within the device. A system bus can include any one or combination of different bus structures such as a memory bus or memory controller, a peripheral bus, a universal serial bus, or a processor or local bus that utilizes any of a variety of bus architectures.

The electronic device 600 also includes one or more memory devices 608 that enable data storage such as random-access memory, non-volatile memory (e.g., read-only memory, flash memory, erasable programmable read-only memory, electrically erasable programmable read-only memory, etc.), and a disk storage device. A memory device 608 provides data-storage mechanisms to store the device data 610, other types of information or data, and various device applications 612 (e.g., software applications). For example, an operating system 614 can be maintained as software instructions with a memory device and executed by the processor system 604.

In embodiments the electronic device 600 includes modules of a texting-while-driving-discouragement system 108 described with reference to FIGS. 1-5. Although represented as a software implementation, the modules of the texting-while-driving-discouragement system 108 may be implemented as any form of a control application, software application, signal-processing and control module, firmware that is installed on the device, a hardware implementation of the controller, and so on. The electronic device 600 also includes one or more sensors 616 that can be part of, or used by, modules of the texting-while-driving-discouragement system 108. For example, the one or more sensors 616 can be sensors 204 or sensors 210 described with reference to FIG. 2.

The electronic device 600 also includes a transceiver 618 that supports wireless communication with other devices or services allowing data and control information to be sent as well as received by the device 600. The wireless communication can be supported using any of a variety of different public or proprietary communication networks or protocols such as cellular networks (e.g., third generation networks, fourth generation networks such as Long Term Evolution networks), wireless local area networks such as Wi-Fi networks, and so forth.

The electronic device 600 can also include an audio or video processing system 620 that processes audio data or passes through the audio and video data to an audio system 622 or to a display system 624. The audio system or the display system may include any devices that process, display, or otherwise render audio, video, display, or image data. Display data and audio signals can be communicated to an audio component or to a display component via a radio frequency link, S-video link, high-definition multimedia interface, composite video link, component video link, digital video interface, analog audio connection, or other similar communication link, such as media-data port 626. In implementations the audio system or the display system are external components to the electronic device. Alternatively or in addition, the display system can be an integrated component of the example electronic device, such as part of an integrated touch interface.

Although embodiments of techniques for discouraging text messaging while driving have been described in language specific to features or methods, the subject of the appended claims is not necessarily limited to the specific features or methods described. Rather, the specific features and methods are disclosed as example implementations of techniques for discouraging text messaging while driving.

1. A method comprising:
first determining whether a user of a wireless-communications device is driving a vehicle;
second determining whether the vehicle is moving at a speed that satisfies a threshold speed;
third determining, by the wireless-communications device, whether the user is text messaging; and
taking a remedial action in response to determining that the user of the wireless-communications device is driving the vehicle both while the vehicle is moving at a speed that satisfies the threshold speed and while the user is text messaging.

2. The method of claim 1 wherein the first, second, and third determinings are performed in any order.

3. The method of claim 1 wherein the first determining comprises:
sensing an ultra-high frequency signal from a speaker of the vehicle;
checking whether the sensed ultra-high frequency signal has at least a threshold strength; and
determining that the user is driving the vehicle in response to the sensed ultra-high frequency having at least the threshold strength.

4. The method of claim 1 wherein the threshold speed comprises zero miles per hour.

5. The method of claim 1 wherein the remedial action comprises sending a notification to a server device to fine the user for text messaging while driving.

6. The method of claim 5 wherein an amount of the fine has been previously agreed to by the user.

7. The method of claim 5 further comprising:
warning the user prior to sending the notification to the server device;
allowing the user to cease text messaging while driving in order to avoid the fine; and
sending the notification to the server device to fine the user in response to the user continuing to text message while driving after the warning.

8. The method of claim 1 wherein the remedial action comprises:
providing a user interface allowing the user to select an audible-messaging option; and
in response to a user input selecting the audible-messaging option, playing back received text messages audibly and receiving user text messages verbally.

9. The method of claim 1 wherein the remedial action comprises disabling text messaging for the wireless-communications device.

10. A wireless-communications device comprising:
a first system to determine that a user of the device is driving a vehicle;
a second system to determine that the user is driving the vehicle at a speed that satisfies a threshold value; and
a processor, operatively coupled to the first and second systems, to:
determine that the user is text messaging; and
take a remedial action in response to determining that the user of the device is driving the vehicle both while the vehicle is moving at a speed that satisfies the threshold value and while the user is text messaging.

11. The wireless-communications device of claim 10 wherein the first system is configured to determine whether the user is driving the vehicle by:
having one or more sensors sense an ultra-high frequency signal from a speaker of the vehicle;
checking whether the sensed ultra-high frequency signal has at least a threshold strength; and
determining that the user is driving the vehicle in response to the sensed ultra-high frequency signal having at least the threshold strength.

12. The wireless-communications device of claim 10 wherein the threshold value comprises zero miles per hour.

13. The wireless-communications device of claim 10 wherein the remedial action comprises sending a notification to a server device to fine the user for text messaging while driving.

14. The wireless-communications device of claim 13 wherein an amount of the fine has been previously agreed to by the user.

15. The wireless-communications device of claim 13 wherein the processor is further to:
warn the user prior to sending the notification to the server device;
allow the user to cease text messaging while driving in order to avoid the fine; and
send the notification to the server device to fine the user in response to the user continuing to text message while driving after the warning.

16. The wireless-communications device of claim 10 wherein the remedial action comprises:
providing a user interface allowing the user to select an audible-messaging option; and
in response to a user input selecting the audible-messaging option, playing back received text messages audibly and receiving user text messages verbally.

17. The wireless-communications device of claim 10 wherein the remedial action comprises disabling text messaging for the device.

18. A method comprising:
receiving, by a server, a notification;
determining by the server, based at least in part on the notification, that a user of a wireless-communications device is driving a vehicle at a speed that satisfies a threshold speed while text messaging; and
charging, by the server, the user an increased fee in response to determining that the user is driving the vehicle at a speed that satisfies the threshold speed while text messaging.

19. The method of claim 18 further comprising:
before receiving the notification, receiving from the user a contractual agreement to the increased fee if the user text messages while driving at a speed that satisfies the threshold speed.

20. The method of claim 18 further comprising donating the increased fee to a charitable organization.
